(19) United States
(12) Patent Application Publication
(10) Pub. No.: US 2003/0151348 A1
(43) Pub. Date: Aug. 14, 2003

(54) Method for making faceplate for laser cathode ray tube

(76) Inventor: Michael D. Tiberi, Woodland Hills, CA (US)

Correspondence Address: LAW OFFICES OF JAMES D. MCFARLAND, 12555 HIGH BLUFF DRIVE, SUITE 305, SAN DIEGO, CA, 92130, US

(21) Appl. No.: 10/364,167

(22) Filed: Feb. 11, 2003

Related U.S. Application Data
(60) Provisional application No. 60/356,027, filed on Feb. 11, 2002.
(60) Provisional application No. 60/419,281, filed on Oct. 17, 2002.

(51) Int. Cl. H01J 29/10

(52) U.S. Cl. 313/461

(57) ABSTRACT

An epoxy-free method for manufacturing a faceplate for a laser-CRT that produces a uniform bonding interface between the laser structure and the transparent substrate during faceplate fabrication such that efficient uniform optical output, thermal expansion coefficient matching, and better heat transfer can be achieved. The faceplate comprises a laser structure including an active gain layer and first and second mirrors on opposite sides of the active gain layer, and a transparent substrate thermal expansion matched to the laser structure and bonded to the laser structure. The laser structure and transparent substrate are bonded using diffusion bonding or sol-gel bonding to create the highly uniform bonding interface.

### CROSS-REFERENCE TO RELATED APPLICATION

Priority is hereby claimed to U.S. Provisional Application No. 60/356,027, filed Feb. 11, 2002, entitled METHOD FOR MAKING FACEPLATE FOR LASER CATHODE RAY TUBE and also to U.S. Provisional Application No. 60/419,281, filed Oct. 17, 2002, entitled LASER CATHODE RAY TUBE, all of which are incorporated by reference herein in their entirety.

### BACKGROUND OF THE INVENTION

1. Field of the Invention

The present invention generally relates to electron beam-pumped lasers, and in particular to the laser configuration commonly known as a laser Cathode Ray Tube (laser-CRT).

2. Description of Related Art

Conventional cathode ray tubes (CRTs) such as those widely used for televisions and computer monitors use phosphors to produce light responsive to an electron beam scanned on the screen containing the phosphors. A conventional CRT includes a funnel-shaped vacuum tube that has a phosphor screen on the wide end, and, on the narrow end, an electron gun including a cathode for generating electrons. External to the CRT, a magnetic coil to focus the electrons into a beam, and a deflection coil to deflect and scan the electron beam. In operation, the phosphors on the screen are energized by the scanning electron beam to emit light.

In comparison, a typical laser-CRT comprises one or more electron beams that address a faceplate formed to provide a plurality of lasers. The electron beam (e-beam) impinges on an active gain layer, such as a semiconductor material, and produces laser action at the incident point of the electron beam. The faceplate may have a plurality of individually formed lasing areas to which the beam is directed, or the faceplate may have a homogeneous structure in which laser action is excited only at the point where the e-beam is directed (i.e. addressed).

The e-beam of a laser-CRT, which may be scanned across the entire screen or individual pixel-addressed, can address a large number of points within a very short time. The laser radiation emitted from each of the points can then be projected using appropriate lenses, coupled directly by an array of optical fibers to direct the laser radiation where it is required for a given application, or utilized in any other desired manner. For example, a laser-CRT can provide very bright, high-resolution laser display devices by scanning the e-beam in a pattern that generates the image to be displayed, thus exhibiting high laser output power characteristics suitable for use for a variety of applications such as projection display devices, optical switches, optical routers, and medical lasers.

The faceplate typically comprises a laser structure connected to a transparent substrate. The laser structure typically includes an active gain layer and two mirrors on opposite sides of the active gain layer. The transparent substrate comprises a material (e.g., sapphire, YAG, or quartz) that is optically transparent at the wavelength of interest. A number of purposes are served by the substrate; for example the substrate provides structural support, it provides a heat sink for the optical cavity, it provides a vacuum seal (as is required for all CRTs), and it provides an outer window to transmit the laser radiation from the optical cavity to the outside world.

Several types of bonding are known for bonding the laser structure to the transparent substrate: 1) optical epoxy bonding, 2) glass bonding, and 3) growth of the laser structure on the substrate. The following paragraphs describe each known bonding process and some of the problems associated therewith.

Conventionally, an optical epoxy is used to bond the laser structure to the optically transparent substrate to form the laser faceplate. Because this optical epoxy will remain in the completed faceplate, the epoxy material should be chosen to have certain properties. For example, 1) the epoxy should be optimized for clarity, so that the laser radiation is transmitted with minimum loss, 2) the epoxy layer should be thin because of its low heat conductivity, 3) the epoxy layer should have low outgassing as it will be encased in the CRT vacuum, and 4) the epoxy should not degrade under electron bombardment. In practice, these requirements are difficult to meet. In fact, optical epoxy is known to cause many problems within a laser-CRT, including decreased lifespan due to degradation of the epoxy layer over time under the action of X-rays and partial penetration of the electron beam, thermal bottleneck in the epoxy layer that decreases output power of the irradiation because of decreased heat removal from the laser structure, outgassing from the epoxy that can seriously contaminate the interior of the laser-CRT, and low heat conductance that causes high thermoelastic stresses at the boundary between the semiconductor member and the epoxy layer.

In an alternative conventional embodiment, the epoxy is substituted with a glass-bonding layer to bond the laser structure to the transparent substrate. In one example of glass bonding, glass powder or fine granules are placed between the substrate and the laser structure and then heated to a temperature above its softening point, which is at least about 400° C. In another example of glass bonding, a glass plate is placed between the substrate and the laser structure and then pressure and heat are applied to bond the faceplate, which requires high temperature (e.g. greater than 400° C.). Although glass bonding may reduce some of the above disadvantages caused by an optical epoxy, glass bonding introduces additional disadvantages. For example, it is difficult to perform glass bonding using glass powder or granules without forming irregularities in the glass bonding layer because of the difficulty involved in evenly applying the bonding layer. Irregularities create a non-uniform glass layer that causes unpredictable variations in the thickness and flatness of the semiconductor, which causes non-uniform optical output and produces inefficient heat transfer. Additionally, glass bonding using a glass plate requires a very high bonding temperature, which may cause damage to the laser structure during the bonding process. Thus, a glass material is difficult to develop that includes the necessary properties for a successful implementation, including transparency, thermal expansion coefficient that matches the laser structure and the transparent substrate, and a melting point that will not cause damage to the mirrors. For example, a glass bonding layer with a melting point (e.g. at least 675° K. (i.e. about 402° C.)) may cause damage to the laser structure during the fabrication process; that is, temperatures of about 400° C. or more are known to cause thermal stresses on the mirrors of the laser structure, which may cause delamination of, or cracks in, one or more layers of the laser structure. In yet another alternative conventional embodiment, the substrate may be overgrown directly on the laser structure. Although the bonding layer is not necessary when the substrate is overgrown, additional disadvantages are introduced. For example, the growth process (e.g., chemical vapor deposition (CVD) or metallo-organic chemical vapor deposition (MOCVD)) is much more complicated and time-consuming than other processes described herein. Another problem with the growth process is that the materials for the both the laser structure and the substrate must be carefully chosen from the same group of materials and they must all possess the necessary properties to perform their respective tasks. For example, if ZnSSe is used to grow the active semiconductor layer, a slightly altered composition of ZnSSe must be used to grow the partially and totally reflective layers on the semiconductor members, and ZnSSe with a different composition must be used to grow the substrate; unfortunately these alterations of composition cause strains in the laser structure, because it is difficult to compensate for strain by using additional compensating layers. Additionally, the requirement to use ZnSSe for the optical substrate sacrifices thermal properties as compared with choosing a substrate such as sapphire (e.g. the thermal conductivity of sapphire is much greater than the thermal conductivity of ZnSSe).

U.S. Pat. No. 5,687,185 to Kozlovsky et al. discloses a faceplate that has a semiconductor structure situated within an optical resonator defined by mirrors and this structure is fastened to a substrate using a fastening layer. The fastening layer is disclosed as epoxy glue or glass layer. The laser target is disclosed as grown directly on a substrate in Example 3 (at col. 15).

U.S. Pat. No. 5,374,870 to Akhekyan et al. discloses a faceplate formed by a screen having a structure formed by a semiconductor member and mirror layers on opposite sides of the semiconductor member, and a support connected to the screen structure by means of a connecting layer, wherein the connecting layer comprises a glass having a softening point of at least 675° K. Thus, the glass bonding method of the '870 patent requires heating the faceplate to a temperature of at least about 675° K. (about 402° C.).

U.S. Pat. No. 5,283,798 to Kozlovsky et al. discloses an epoxy-free method of making a laser screen in which the support member is overgrown on the laser structure. The laser screen and support member are made of materials selected from the same group; for example, semiconductor compounds selected from the group consisting of binary, three-component and four-component compounds of elements of the second and sixth Groups of the Periodic System, which unfortunately severely restricts the material that may be used. Furthermore, only small variations in the compositions are allowed; for example, the '798 patent discloses that too much altering of the compound that forms the support and semiconductor members (e.g., substituting more than 15% of atoms for isovalent atoms as compared to the compound that forms the semiconductor) can cause strong disagreement between expansion coefficients of materials of the semiconductor and support member, which can cause high thermoelastic stresses in the laser screen structure resulting in cracking or stratification of the screen and a shorter service life.

### SUMMARY OF THE INVENTION

An epoxy-free method for manufacturing a faceplate for a laser-CRT is disclosed that produces a uniform bonding interface between the laser structure and the transparent substrate during faceplate fabrication such that efficient uniform optical output, thermal expansion coefficient matching, and better heat transfer can be achieved.

The epoxy-free faceplate comprises a laser structure including an active gain layer (e.g., a single crystal wafer comprising a II-VI semiconductor compound, a single crystal layer including at least one of II-VI and III-V compounds grown on a sacrificial substrate, or a multiple quantum well configuration) and first and second mirrors (e.g. a partially reflective layer and a total reflector) on opposite sides of the active gain layer, and a transparent substrate (e.g., sapphire, YAG, or quartz glass) thermal-expansion matched to the laser structure and bonded to the partially reflective layer such that a highly uniform interface is formed between the laser structure and the substrate.

In one embodiment, diffusion bonding is used to bond the laser structure to the transparent substrate. In this embodiment, the transparent substrate directly adjoins the laser structure such that a substantially uniform seamless joint is defined there between. Because there is no separate fastening layer, the faceplate possesses a highly uniform thickness and therefore the optical output will also be highly uniform. Additionally, because the diffusion bonding is accomplished at a temperature of about 300° C. or less, the laser structure will remain stable (e.g., the mirrors and active gain layer will not delaminate or crack) during the bonding process. Furthermore, because the coefficient of thermal expansion of the laser structure and transparent substrate substantially match, undesirable thermally-induced stresses or cracks are avoided during heating of the faceplate.

In an alternative embodiment, the uniform interface comprises a fastening layer formed by uniformly spin-coating a sol-gel material on at least one of the laser structure and the transparent substrate. Because the sol-gel is viscous and applied by spin-coating, the resulting fastening layer is highly uniform, which enables efficient uniform optical output of the faceplate. Because the bonding temperature of the sol-gel is about 300° C. or less, the laser structure will remain stable (e.g., the mirrors will not delaminate or crack) during the bonding process. The coefficient of heat expansion of the fastening layer approximately matches the coefficient of heat expansion of the transparent structure and laser structure such that undesirable thermally-induced stresses or cracks are avoided during heating of the faceplate.

### BRIEF DESCRIPTION OF THE DRAWINGS

For a more complete understanding of this invention, reference is now made to the following detailed description of the embodiments as illustrated in the accompanying drawing, wherein:

FIG. 1 is a cross-sectional view of a laser-CRT;

FIG. 2 Is a cross-sectional view of a portion of a complete laser faceplate;

FIG. 3 is a cross-sectional view of a workpiece that will be used to form the laser structure, and the transparent substrate prior to bonding;

FIG. 4 is a cross-sectional view of the combined workpiece and transparent substrate of FIG. 3 situated within a heating/vacuum chamber, wherein heat and pressure are applied to bond them together using diffusion bonding;

FIG. 5 is a cross-sectional view of a portion of a workpiece that will form the laser structure and a transparent substrate with a sol-gel coating thereon, prior to sol-gel bonding to form the faceplate;

FIG. 6 is a cross-sectional view of the workpiece and substrate of FIG. 5 brought together and situated within a heating/vacuum chamber;

FIG. 7 is a cross-sectional view of a completed section of the sol-gel bonded faceplate;

FIG. 8 is a cross-sectional view of a semiconductor laser wafer mounted to a backing plate;

FIG. 9 is a cross-sectional view of a partially reflective layer formed on a polished surface of the wafer;

FIG. 10 is a cross-sectional view of a structure resulting after the coated semiconductor laser wafer surface is bonded to the substrate;

FIG. 11 is a cross-sectional view of wafer after the backing plate has been removed and the wafer ground and polished;

FIG. 12 is a cross-sectional view of a portion of a completed faceplate, including a total reflector formed on the polished surface of the wafer.

FIG. 13 is a cross-sectional view of faceplate and a portion of a tube that will be used to form the laser-CRT, illustrating a first step in fabrication of a laser-CRT in which the tube and faceplate are prepared for bonding;

FIG. 14 is a cross-sectional view of the faceplate and a portion of the tube, illustrating a step in the fabrication of a laser-CRT, including applying a binder to the tube;

FIG. 15 is a cross-sectional view of the faceplate and a portion of the tube, illustrating an actual bonding step in the fabrication of a laser-CRT wherein a tube and faceplate are brought together and heated in a heating/vacuum chamber; and

FIG. 16 is a schematic view of one example of a projection system that utilizes laser-CRTs.

### DETAILED DESCRIPTION

This invention is described in the following description with reference to the figures, in which like numbers represent the same or similar elements.

Glossary of Terms and Acronyms

The following terms and acronyms are used throughout the detailed description:

| | |
|---|---|
| CRT | Cathode Ray Tube |
| GaAs | Gallium Arsenate |
| GLV | Grating Light Valve (a type of SLM) |
| MBE | Molecular Beam Epitaxy |
| MOCVD | Metallo-organic chemical vapor deposition |
| MRF | Magnetorheological finishing |
| SLM | Spatial Light Modulator |
| YAG | Yttrium Aluminum Garnet |
| ZnSSe | Zinc Sulfide Selenide |

Overall Description of Laser-CRT

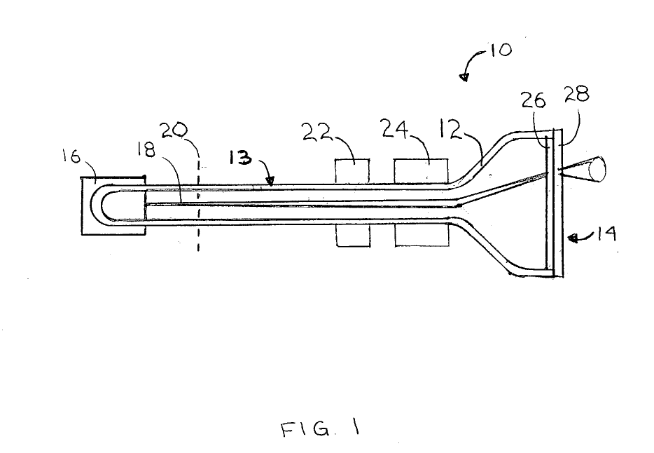

FIG. 1 is a cross-sectional view of a laser-CRT 10 that includes a funnel-shaped vacuum tube 12 on one end, and a narrow, tube-shaped section 13 extending from the opposite end. A laser faceplate 14 is situated on the wide end of the vacuum tube, and the narrow opposite end 13 of the vacuum tube includes an electron source 16 that generates an electron beam (e-beam) 18 directed toward the faceplate 14. In one embodiment, the electron source 16 of the laser-CRT 10 includes an e-beam current control 20 for controlling the electron beam 18, a focusing system 22 arranged to assist in focusing the beam to a small spot size, and a deflection system 24 arranged to deflect the electron beam to the desired screen location in response to the applied video signal. One example of a laser-CRT structure is disclosed in U.S. Provisional Patent Application No. 60/419,281, which has been incorporated by reference herein.

The faceplate includes a laser structure 26 and a substrate 28 that comprises a transparent and heat conductive material. As described herein in detail, the laser structure 26 will be bonded to the substrate 28 to form a multilayer structure. Since the laser structure 26 is typically homogeneous across the faceplate, laser action is created at the point on the faceplate wherever an e-beam with sufficient intensity is incident. Pixels are defined by the target of the electron beam 18 on the faceplate; particularly, the area at which the electron beam is incident becomes a pixel. In some embodiments a “screen mask” could be positioned proximate to the faceplate to define the pixels by allowing the e-beam to pass through only the defined gaps in the mask.

It is advantageous for the thickness of active layer to be approximately uniform across the faceplate, so that the emission intensity is consistent across the faceplate. Also, there is generally an optimum thickness (e.g. 10 microns) at which laser action has high efficiency, and it is advantageous if this optimum thickness can be achieved uniformly across the faceplate, so that each pixel has an approximately equal brightness across the entire faceplate.

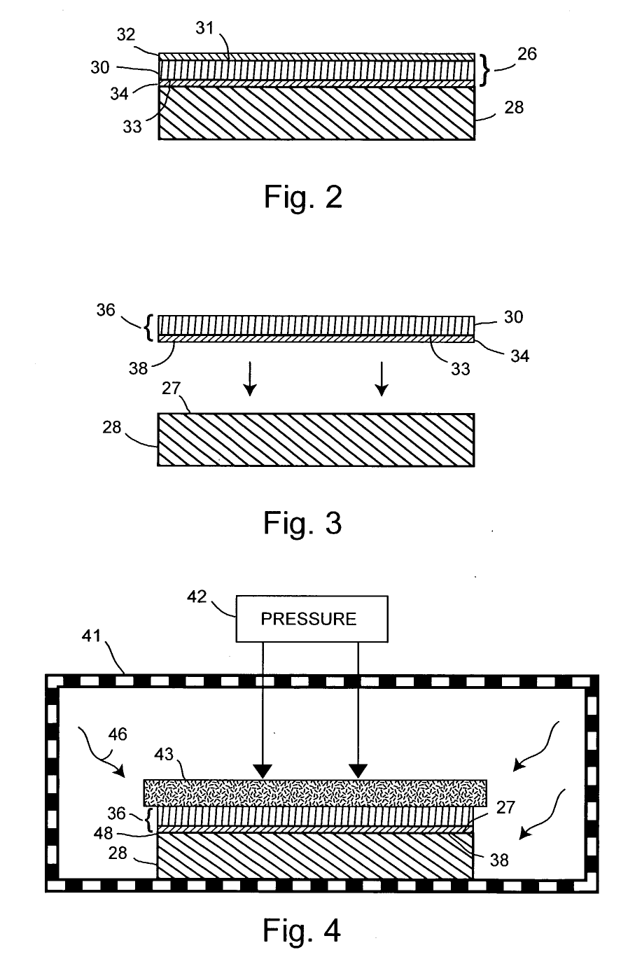

Reference is now made to FIG. 2, which is a cross-sectional view of a section of a complete laser faceplate, showing the laser structure 26 connected to the transparent substrate 28.

Laser Structure

In the embodiment of FIG. 2 the laser structure 26 includes a layer of active gain material 30 situated between two mirrors, including a total reflector 32 formed on a first surface 31 (shown as the upper surface in FIG. 2) of the active gain layer, and a partially reflective layer 34 formed on an opposite, second surface 33 (shown as the lower surface in FIG. 2) of the active gain layer 30.

The laser structure 26 comprises any suitable material(s) and any suitable configuration for generating laser radiation in response to excitation by an electron beam. In some embodiments, the active gain layer 30 is fabricated from a single crystal semiconductor laser wafer of a II-VI compound such as CdS (green), CdSSe (red), or ZnSSe (blue). In alternative embodiments, the active gain layer comprises any suitable gain material that can be pumped by an electron beam, for example III-V semiconductor materials (e.g., InGaN, GaN, InN, InAlGaAs, etc.) or other II-VI materials could be used to provide the active gain layer. In some alternative embodiments, the active gain layer may comprise one or multiple quantum wells. In some of the following description, the active gain layer is illustrated by a semiconductor laser wafer; however, it should be apparent that other materials and configurations could be used.

The partially reflective layer 34 is provided by any suitable structure, such as a dielectric output coupling mirror comprising a number of alternating layers of TiO₂, SiO₂, Al₂O₃, HfO₂, or ZrO₂, for example. Typically, the second surface 33 of the active gain layer 30 is polished prior to forming the partially reflective layer in order to provide a smooth, uniform surface, as described herein in detail. The partially reflective layer 34 may be deposited on the polished surface of the semiconductor laser wafer using any of the various thin film-coating techniques such as ion beam deposition or ion-assisted deposition in some embodiments. For example, in one embodiment the thin film coating is designed to transmit 2% to 15% of the specific wavelength of light generated in the optical cavity.

The total reflector 32 is provided by any suitable structure, such as a multilayer dielectric/metallic coating. The total reflector provides one end of the optical cavity, and also provides the conducting target for the electron beam. The first surface 31 of the active gain layer 30 is typically polished prior to forming the total reflector 32 thereon.

In one example, the laser structure comprises a single crystal wafer of a II-VI semiconductor laser material that is cut from a boule into a circular wafer of 40-80 mm in diameter and 0.5 mm to 2 mm in thickness. The semiconductor laser crystal is polished to a thickness of 5-50 microns, and laser mirror coatings are deposited on both sides to form an optical cavity that produces laser action at the incident point of the electron beam such as described above. In some embodiments it has been found that good results are achieved with a thickness of 10 microns.

In an alternative method of fabricating the laser structure 26, the active gain layer 30 and the mirrors 32, 34 may be epitaxially grown on a removable growth substrate. For example, an active gain layer may be epitaxially deposited using techniques such as molecular beam epitaxy (MBE) or metallo-organic chemical vapor deposition (MOCVD) on GaAs as a growth substrate. An active gain layer comprising a uniform single crystal of a II-VI or III-V material is grown to a thickness of under 10 microns. In some laser structures, the active gain layer may comprise a number of additional layers such as quantum wells and barriers, as described in U.S. Pat. No. 5,687,185. By depositing the active gain layer epitaxially there may be no need for a final polish because the layer can be grown to the thickness desired. Mirror coatings may be grown by epitaxial growth of appropriate layers such as described in U.S. Pat. No. 5,687,185, or applied in similar manner to the coating on the single crystal wafer to form an optical cavity, or a combination of both. The GaAs growth substrate is removed at the appropriate step by, for example, chemical etching.

Substrate

The substrate 28, shown in FIG. 2, comprises a suitable optical material that is substantially transparent at the wavelength of interest, such as sapphire, white YAG, or quartz glass. Also, the substrate is selected so that the coefficient of thermal expansion of the substrate closely matches that of the laser structure so that the materials minimize stress, strain, and cracking that would otherwise occur due to the temperature changes during fabrication, and especially those occurring during the bonding process. For example, sapphire may provide an excellent material for green and red laser structures, and white YAG may provide an excellent choice for blue laser structures. Furthermore, the substrate should be selected to provide high thermal conductivity, in order to provide good heat transfer from the laser structure through the substrate 28.

The substrate performs a number of functions; for example the substrate 28 provides structural support for the faceplate 14, a heat sink for the laser structure 26, a vacuum seal (as is required for all CRTs), and an outer window to transmit the laser radiation from the optical cavity 30 to the outside world.

The transparent substrate 28 has an upper surface 27 for bonding with the laser structure. The bonding surface 27 of the transparent substrate 28 may comprise an anti-reflective coating or a micro-roughness surface as described in U.S. Pat. No. 5,339,003, for the purpose of preventing unwanted reflection.

Bonding Processes

An epoxy-free bonding process is described herein for making the faceplate of a laser-CRT. The resulting faceplate structure, such as shown in FIG. 2, includes the laser structure 26 bonded to the transparent substrate 28, which is thermal expansion matched to the laser structure, thus a highly uniform interface is formed between the laser structure and the substrate. Following are two examples of bonding processes that provide such epoxy-free bonded faceplates.

It may be noted that at some point in the fabrication process, the substrate 28 must be bonded to a workpiece that will become the laser structure. At the time of bonding, the laser structure is usually not yet complete; i.e. additional processing is typically required. For example, it may be advantageous for bonding to be done when the in-process laser structure workpiece comprises only an active gain layer 30 and the partially reflective layer 34, and then after bonding additional steps would be performed to fabricate the active layer to the desired thickness, polish the first surface 31, and then deposit the total reflector 32 to complete the laser structure 26. Accordingly for purposes of description, the laser structure while in-process is referenced by workpiece 36, which is illustrated in the example of FIG. 3 to include the active layer 30 and the partial reflector 34. It should be apparent that the workpiece 36 in other embodiments may have a different structure such as may be necessary or desirable for a particular process.

### EXAMPLE 1

### Diffusion Bonded Faceplate

Reference is made to FIGS. 3 and 4 to illustrate a diffusion bonding process in which the workpiece 36 for a laser structure is diffusion-bonded to the transparent substrate 28 in the process of forming a diffusion-bonded faceplate. In the diffusion process as will be described, the two surfaces are bonded together at the molecular level, creating a substantially uniform seamless joint.

FIG. 3 is a cross sectional view of the workpiece 36 and substrate 28, with the workpiece positioned apart from the substrate prior to bonding. Prior to diffusion bonding, the second (lower) surface 33 of the active gain layer 30 and the bonding surface 27 of the transparent substrate 28 (the upper substrate surface as shown in FIG. 3) are prepared by polishing to a high degree of smoothness. For example, the two surfaces may be polished using magnetorheological finishing (MRF). MRF is a polishing process that begins by placing a surface at a fixed distance from a moving spherical wheel. An electromagnet located below the wheel surface generates a gradient magnetic field in the gap between the wheel and surface to be polished. When the magnetorheological (MR) fluid is delivered to the wheel, it is pulled against the wheel surface by the magnetic field gradient. The fluid acquires the wheel velocity, develops high stresses, and becomes a sub-aperture polishing tool. A sophisticated computer program determines a schedule for varying the position of the rotating surface through the polishing zone. The MRF polishing process provides a highly polished surface without surface and subsurface damage that would be otherwise induced by conventional polishing; thus, there is no need for additional chemical etching. Examples of the MRF process are disclosed in U.S. Pat. Nos. 5,577,948, 5,971,835, and 5,951,369, which are incorporated by reference herein.

For good results in the diffusion bonding process, the surfaces to be bonded must have a high degree of smoothness; for example one-tenth of a wavelength (λ/10) is desirable, greater smoothness is better. MRF processes have been shown to provide high degree of smoothness in bonding the workpiece to the substrate, up to at least λ/20. However, any process that can be utilized to provide a sufficient degree of smoothness can be used, such as more conventional rotary polishing techniques.

One advantage of the MRF process is that polishing is performed without introducing the undesirable mechanical stresses of conventional processes in which the surface is polished by rotary motion. By eliminating the mechanical stresses, the MRF process can improve production yield and product quality. Particularly, the MRF process can produce surfaces that are highly uniformly flat, highly polished, and do not require additional chemical etching to correct damage induced by conventional mechanical polishing, which can advantageously improve bonding quality, product uniformity, and laser performance.

After the second surface 33 of the active gain layer 30 has been polished, the partially reflective layer 34 is then deposited before bonding. It should be noted that the smoothness of the partially reflective layer will substantially assume the smoothness of the polished surface 33, and therefore the partially reflective layer will have an outer surface 38 that is very smooth and uniform. It may also be noted that the outer surface 38 of the partially reflective layer is what is actually bonds to the adjacent bonding surface 27.

After the bonding surface 27 of the transparent substrate has been polished, the substrate may be bonded directly to the workpiece 36. Optionally, an anti-reflective coating or a micro-roughness surface may be formed on the bonding surface 27 of the transparent substrate 28 as described in U.S. Pat. No. 5,339,003, for the purpose of reducing optical losses by preventing unwanted reflection. Additionally, in some embodiments a thin layer of material (e.g., 50 to 100 angstrom of SiO₂) may be deposited onto the bonding surface of the substrate. Because diffusion bonding has been found to achieve stronger bonds when the molecular composition of the bonding surfaces more closely match each other, the thin layer of material deposited on the substrate should approximately match the material on the bonding surface of the laser structure.

Reference is now made to FIG. 4. After preparation of the two surfaces to be bonded, pressure 42 and heat 46 are applied in a way to bond together the two surfaces at the molecular level, creating a substantially uniform seamless joint 48.

FIG. 4 is a view of the workpiece 36 situated adjacent to the substrate 28 within a heating/vacuum chamber 41. Pressure, shown at 42, is applied to the workpiece and substrate in a manner to press together the two bonding surfaces at a desired pressure. To assist in applying pressure uniformly to the workpiece, an optional plate 43 may be utilized. Heat 46 generated by the heating/vacuum chamber 41 is applied to the workpiece 36. The combination of heat and pressure over time bonds the two surfaces such that a highly uniform interface 48 is formed there between. In one example embodiment, a workpiece with an approximately 2″ diameter is bonded to a transparent substrate 28 using about 20 pounds of pressure at 300° C. In alternative embodiments, the pressure and temperature may be varied within the limits imposed by the strength of the laser structure to provide the desired bond. It should be noted that in some embodiments, the heating chamber 41 may comprise a vacuum so that the bonding process may be performed in a vacuum or inert gas to ensure oxidation does not occur; however in some alternative embodiments, a vacuum may not be required.

To enhance the diffusion bonding process between the two opposing surfaces, it may be desirable for the two surfaces to consist of substantially the same material. For example, the partially reflective layer 34 could comprise a material similar to the transparent substrate 28, or a layer of this material could be deposited on the bonding surface 27 of the transparent substrate before bonding. Alternatively, a partially reflective coating comprising the same material as the partially reflective layer 34 may be deposited on the bonding surface 27 of the transparent substrate, so that the partially reflective layer is split between the adjacent surfaces of the transparent substrate and the laser structure.

After the bonding process has been accomplished, the bonded assembly is removed from the heating/vacuum chamber, and additional processing steps are performed to complete the laser structure. For example, the upper (first) surface 31 may be polished and then the total reflector 32 deposited thereon. Alternately, other structures may be created before forming the total reflector, and/or other structures may be formed on top of the total reflector.

One example of a resulting structure is shown in the cross-section of FIG. 2. This structure provides a diffusion-bonded faceplate 14, wherein the laser structure 26 directly adjoins the transparent substrate 28; that is, there is no separate fastening layer disposed therebetween. Because there is no separate fastening layer, the faceplate possesses a highly uniform thickness and therefore the optical output will also be highly uniform. Additionally, because the diffusion bonding is accomplished at a temperature of about 300° C. or less, the laser structure will remain stable (e.g., the mirrors will not delaminate or crack) during the bonding process. Furthermore, because the coefficient of thermal expansion of the laser structure and transparent substrate match, no stresses or cracks will occur during any heating of the faceplate.

### EXAMPLE 2

### Sol-Gel Bonding

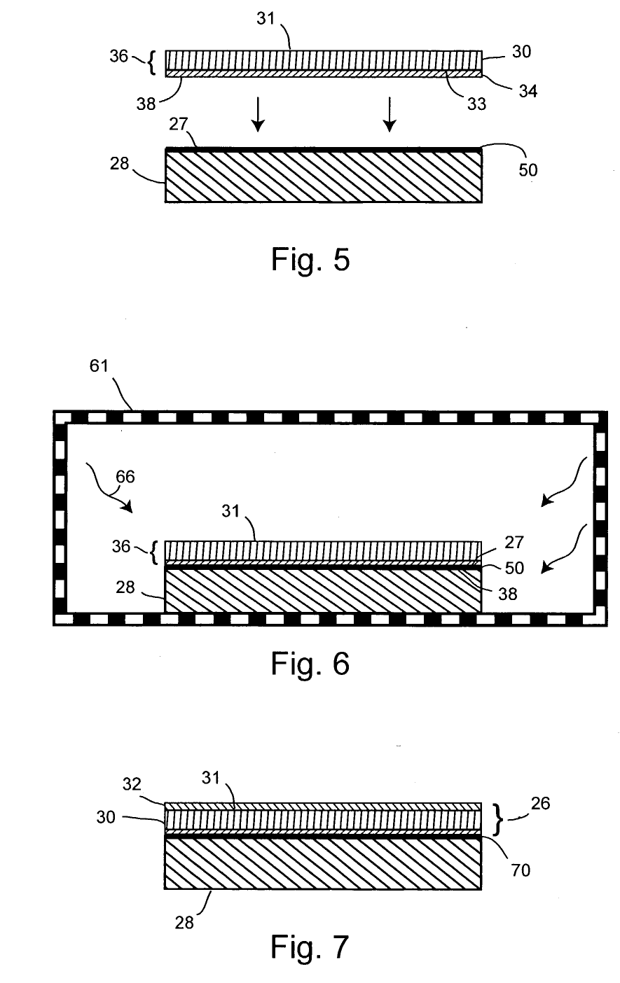

Reference is now made to FIGS. 5 to 7, which are cross-sectional views of the laser structure 26 and transparent substrate 28 in several stages of the sol-gel bonding process. FIGS. 5 to 7 are used to illustrate the process of forming an epoxy-free faceplate using sol-gel bonding.

FIG. 5 is a cross-sectional view of the workpiece 36 and the transparent substrate 28 with a coating 50 of sol-gel deposited thereon. It should be noted that although the sol-gel coating 50 is shown only on the bonding surface 27 of the transparent substrate 28, the sol-gel may be applied to the workpiece 36 in place of, or in addition to, the transparent substrate.

In one embodiment, the sol-gel coating 50 comprises SiO₂ suspended in a solution of organic precursors. Sol-gel materials are available from a number of vendors, such as Chemat Technology, Inc. of Northridge, Calif. The starting materials used in the preparation of the “sol” are usually inorganic metals salts or metal organic compounds such as metal alkoxides. In a typical sol-gel process, the precursor is subjected to a series of hydrolysis and polymeration reactions to form a colloidal suspension, or a “sol”.

Uniform thin films of sol-gel can be produced on the surface by spin-coating or dip-coating. In one embodiment, the sol-gel coating 50 is applied to the transparent substrate 28 by a spin-coating process; thus, a uniform thin layer is achieved. Additionally, it should be noted that the spin-coated sol-gel may optionally be partially baked on the surface of the transparent substrate prior to connecting the workpiece 36 and the transparent substrate 28. Partially baking the sol-gel at a high temperature for a short period prior to connecting the bonding surfaces may advantageously remove a portion of the organic materials.

FIG. 6 is a cross-sectional view of the workpiece 36 and substrate 28 brought together and situated within a heating/vacuum chamber 61 that applies heat 66 to re-melt and remove the remainder of the organic precursors in the sol-gel coating 50. It should be noted that in some embodiments, the heating chamber 61 may comprise a vacuum so that the bonding process may be performed in a vacuum or inert gas to ensure oxidation does not occur; however in some alternative embodiments, a vacuum may not be required.

The sol-gel process is a versatile solution process for making ceramic and glass material. One example of a sol-gel bonding process is disclosed in U.S. Pat. No. 5,516,388, entitled SOL-GEL BONDING, issued May 14, 1996. In general, the sol-gel process involves the transition of a system from a liquid “sol” (mostly colloidal) into solid “gel” phase. Applying the sol-gel process, it is possible to fabricate ceramic or glass materials in a wide variety of forms: ultra-fine or spherical shaped powders, thin film coating, ceramic fibers, microporous inorganic membranes, monolithic ceramics and glasses, or extremely porous aerogel materials.

In one embodiment, heat 66 is applied to the sol-gel 50 to a bonding temperature of about 300° C. In alternative embodiments, the bonding temperature may be higher or lower and some small pressure may be applied. The process may be performed in a vacuum or in inert gas to prevent oxidation.

Although the bonding temperature of the sol-gel bond is about 300° C. in this embodiment, it may be noted that the melting point of the bond will be much higher (e.g., 1800° C.) due to the properties of the remaining bonding material (e.g., SiO₂), which provides a strong, robust bond.

After the sol-gel bonding process has been accomplished, the bonded assembly is removed from the heating/vacuum chamber, and additional processing steps are performed to complete the laser structure. For example, the upper surface 31 may be polished and then the total reflector 32 deposited thereon. Alternately, other structures may be created before forming the total reflector, and/or other structures may be formed on top of the total reflector.

FIG. 7 is a cross-sectional view of a completed section of the sol-gel bonded faceplate 14, including the transparent substrate 28 bonded to the laser structure 26 with the highly uniform sol-gel fastening layer 70 there between. The fastening layer 70 is highly uniform due to the spin-coating used to coat the sol-gel on the substrate 28. Because the sol-gel solution is viscous, any irregularities in the bonding surfaces are “filled-in” during the coating process reducing the need for polishing, and improving the uniformity of the fastening layer. The coefficient of heat expansion of the fastening layer 70 may be selected to substantially match that of the transparent substrate 28 and the laser structure 26 to ensure stability of the laser structure during the heating process. The index of refraction of the fastening layer 70 may also be designed to maximize optical efficiency within the fastening layer (e.g., to match that of the transparent substrate).

Method for Fabricating Faceplate

As discussed above, the bonding process is only one part of the overall procedure for fabricating the faceplate of a laser-CRT. From start to finish, a number of additional steps (both before and after bonding) are required to fabricate a complete faceplate. There are many different procedures that can be employed and many different processes; for example as described above with reference to FIGS. 2 to 4 in relation to the diffusion bonding process, an MRF process may be used to polish the surfaces, thereby avoiding the stresses introduced by conventional mechanical procedures, minimizing damage to the first and second surfaces 31, 33 of the active gain layer 30, and minimizing sub-surface damage to the active gain layer, all of which would otherwise decrease power efficiency. Furthermore, a backing plate is not required if an MRF polishing process is utilized.

Described below is one example procedure for forming a faceplate that utilizes a backing plate for structural support of the workpiece during the fabrication procedure; however it should be apparent that many other procedures, with or without a backing plate, are possible.

Method of Fabrication of the Faceplate Using a Backing Plate

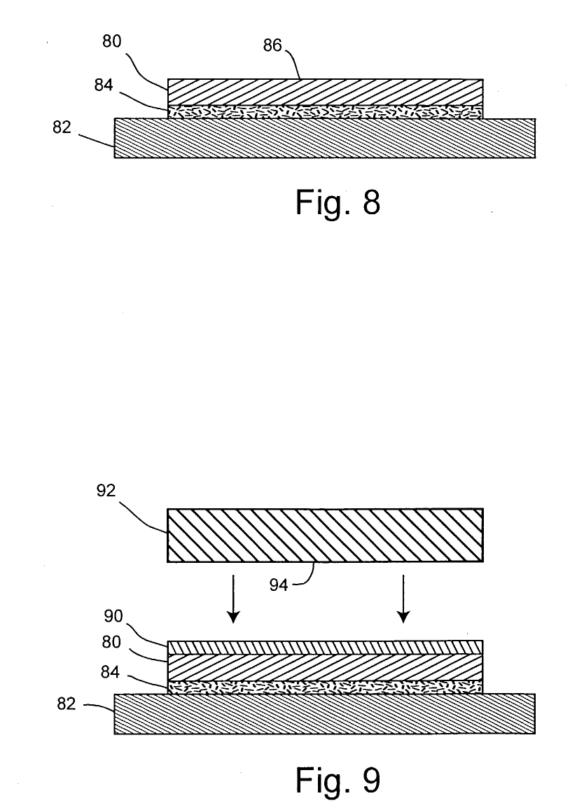

Reference is now made to FIGS. 8 to 12, which together show a sequence of cross-sectional views of a workpiece. These FIGS. 8 to 12 are used to illustrate a procedure for fabricating a faceplate.

FIG. 8 is a cross-sectional view of a semiconductor laser wafer 80 mounted to a backing plate 82. The semiconductor laser wafer comprises an gain material 30 such as described with reference to FIG. 2.

The backing plate 82 comprises a material and structure that provides stability to the workpiece during the fabrication process, and accordingly the backing plate must have sufficient thickness to insure mechanical stability of the workpiece during polishing and subsequent thin film coating operations. Furthermore, the backing plate should comprise a material whose thermal expansion coefficient is closely matched to the selected semiconductor crystal wafer. It should be noted that the backing plate will be removed in the final stages of the fabrication process.

To mount the semiconductor layer 80 to the backing plate 82, an adhesive layer 84 comprising an adhesive such as an epoxy is applied. It should be noted that this adhesive will be removed in the final stages together with the backing plate. This epoxy should be of a low outgassing type so that it will not contaminate the vacuum during thin-film coating operations. In an alternative embodiment, glass frit that is thermal expansion matched to the semiconductor layer 80 and backing plate 82 may be used for the adhesive layer 84.

After the semiconductor laser wafer 80 has been mounted to the backing plate, the exposed surface 86 of the semiconductor laser wafer is polished to a high degree of flatness and smoothness using any suitable polishing process.

FIG. 9 shows a partially reflective layer 90 formed on the polished surface 86, which will provide an output coupler in the finished product. In one embodiment the partially reflective layer 90 comprises a dielectric output coupling mirror comprising a number of alternating layers of for example TiO₂, SiO₂, Al₂O₃, HfO₂, or ZrO₂ deposited on the polished surface of the semiconductor laser wafer using any of the various thin film coating techniques such as ion beam deposition or ion-assisted deposition. The thin film coating is designed to transmit for example 2 to 15 percent of the specific wavelength of light generated in the optical cavity.

FIG. 9 also shows a transparent substrate 92 that will be bonded to the coated surface 90 of the semiconductor laser wafer using an epoxy-free bonding method as described herein. The transparent substrate 92 comprises a material such as sapphire, white YAG, or quartz glass. A bonding surface 94 of the transparent substrate is first prepared in an appropriate manner, for example, applying an anti-reflective coating or creating a micro-roughness surface as described in U.S. Pat. No. 5,339,003 prevents unwanted reflection back into the laser structure, and depositing a thin layer (e.g., 50 to 100 angstrom) of SiO₂ to the bonding surface of the substrate improves the diffusion bonding process in some embodiments.

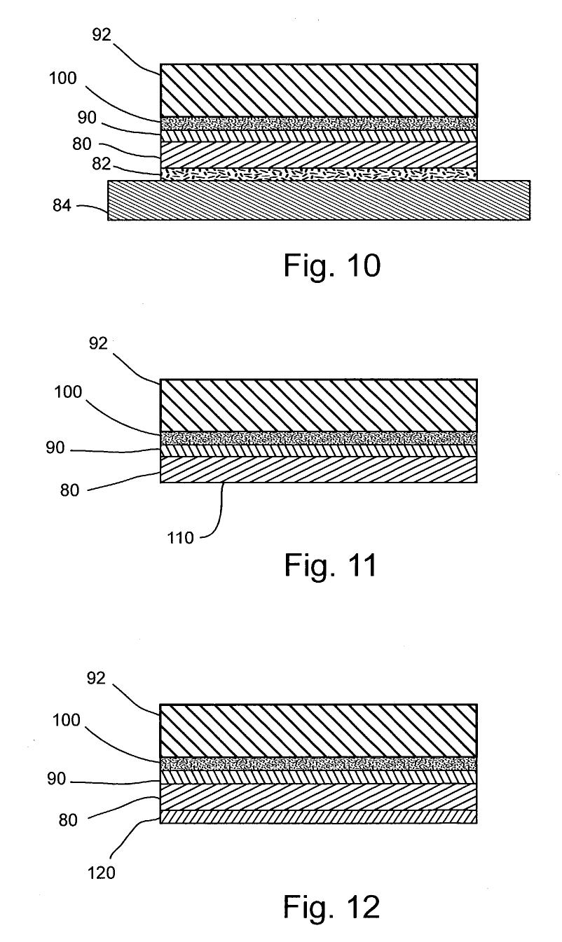

FIG. 10 shows the resulting workpiece after bonding the coated semiconductor laser wafer surface to the transparent substrate using an epoxy-free process such as diffusion bonding or sol-gel bonding described elsewhere in detail. A bonding region 100 is created between the semiconductor laser wafer and the transparent substrate. The bonding region 100 illustrates the bond created by the processes, and it may or may not comprise a separate layer; for example the sol-gel bonding process will create a sol-gel layer, in contrast diffusion bonding does not create a separate layer.

Referring now to FIG. 11, the backing plate is removed by any suitable process such as etching or grinding, and then the exposed surface 110 of the semiconductor laser wafer 80 is ground to the desired thickness and polished using any suitable process.

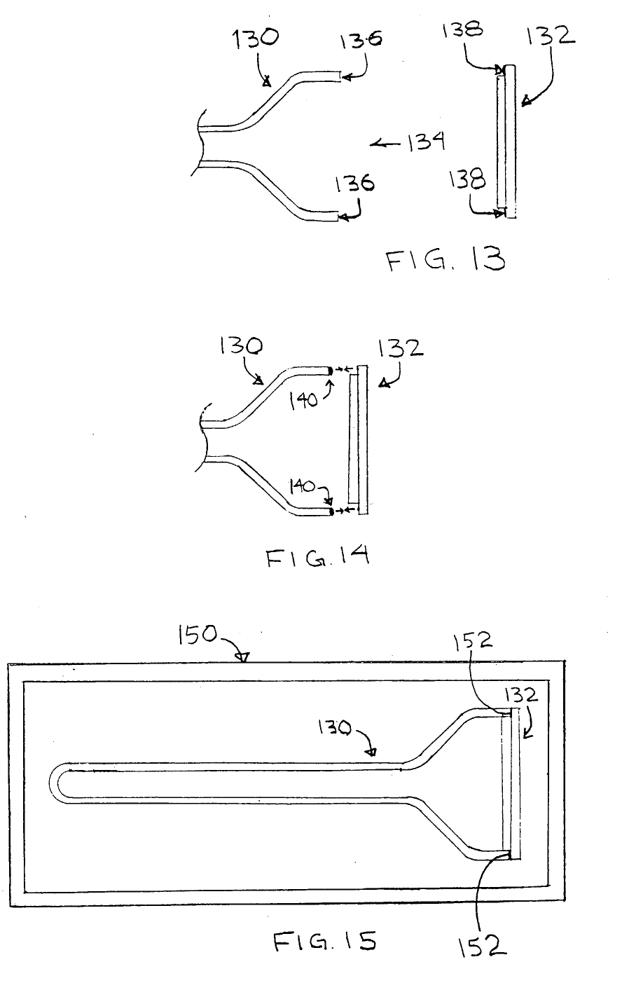

Referring now to FIG. 12, a total reflector 120 is formed on the polished surface 110 of the semiconductor laser wafer to form one end of the optical cavity. For example a dielectric/metallic coating is applied to form the total reflecting mirror of the optical cavity and the conducting target for the electron beam.

The finished laser faceplate shown in FIG. 12 is then cut to the desired shape and coupled to an electron beam source such as a cathode ray tube to form the laser-CRT, as will be described below in one example.

It should be recognized that the above description is simplified for purposes of illustration, and that variations of the fabrication process are possible, for example to add additional layers or components.

Fabrication of Laser-CRT

Conventionally, a laser faceplate is bonded to the tube using an epoxy; however, the operational lifetimes of laser-CRTs fabricated by the conventional methods are significantly limited by degradation of the optical epoxy, such as from x-rays generated by the electron beam as an unintended by-product. X-ray degradation can limit the laser-CRT lifetimes to hundreds or at most a few thousand of hours. Additional drawbacks of epoxy bonding include sensitivity to heating, out-gassing within the vacuum tube, and expensive and unsafe manufacture of laser-CRT's for the general public because of danger of voltage from inside the tube leaking out. An epoxy-free tube to faceplate bonding method is described below.

FIGS. 13 to 15 are cross-sectional views showing one example of the steps involved in fabricating a laser-CRT using an epoxy-free process to connect the faceplate to a tube. Epoxy-free bonding of a faceplate with a tube is advantageous for a number of reasons such as low cost manufacture that can be achieved through economies of scale such as those achieved in conventional CRT fabrication processes. Furthermore, the epoxy-free CRT fabrication process advantageously seals the voltage inside the CRT, making it safer for consumer applications.

It may be noted that the faceplate utilized in the CRT fabrication procedure is an epoxy-free faceplate such as described herein; this is advantageous because other faceplates (i.e. faceplates with epoxy) cannot withstand the heat of glass bonding without degrading the bond and contaminating the vacuum inside the tube.

FIG. 13 illustrates the tube 130 and epoxy-free faceplate 132 during the preparation stage. Particularly, FIG. 13 illustrates a funnel shaped tube 130 with its wide-end 134 exposed. The end surface 136 of the wide-end of the funnel is ground for flatness to prepare the surface for the bonding process. A laser faceplate 132 is also illustrated, such as described in more detail with reference to FIGS. 2 and 7. Gold 138 is painted on an outer edge portion of the faceplate; particularly, the gold 138 is painted on the portion of the faceplate 132 that will become the bonding area of the faceplate 132 to the tube 130 as shown in FIG. 13.

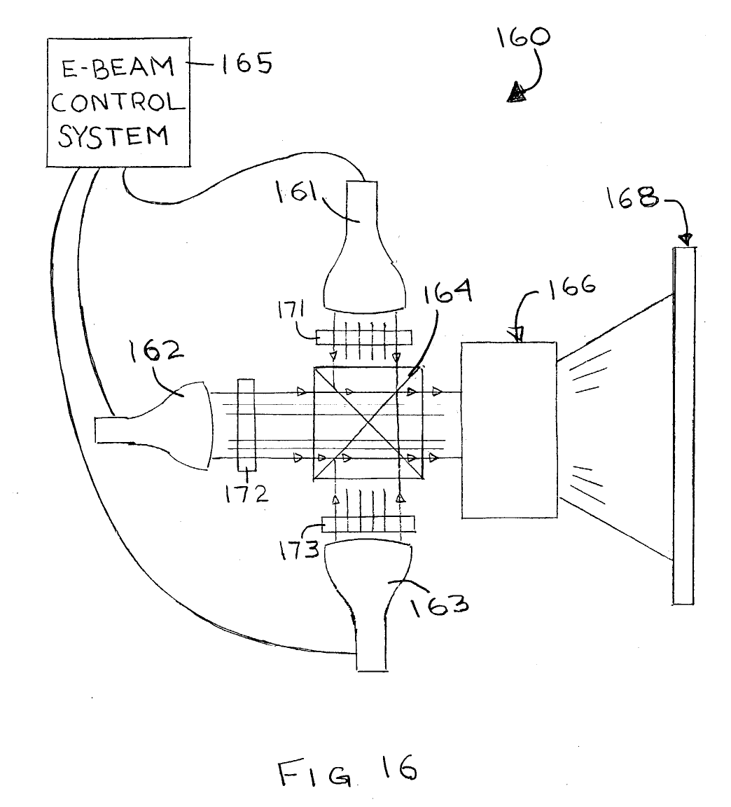

FIG. 14 illustrates the initial bonding step in which the binder 140 is applied to the prepared (e.g. ground) surfaces 136 of the tube 130. It should be noted that the binder may be applied to the faceplate 132 instead of, or in addition to, the tube. In one embodiment, the binder material comprises glass (e.g., glass frit mixed with a light adhesive); however, it should be understood that other epoxy-free binders, such as sol-gel, may be used to bond the tube to the faceplate. After applying the binder to the prepared surface(s), the tube and faceplate are placed into a vacuum chamber (not shown) and pushed together form a temporary bond.

FIG. 15 illustrates the tube 130 and faceplate 132 assembly being heated in a heating/vacuum chamber 150. In one embodiment, wherein glass is chosen to bond the faceplate to the tube, the tube and faceplate assembly is heated to the melting point of the glass to permanently bond the tube to the faceplate. In this embodiment, glass may have a melting point in a range of 200° C. to 400° C. It should be noted that in some embodiments, the heating chamber 150 may comprise a vacuum so that the bonding process may be performed in a vacuum or inert gas to ensure oxidation does not occur; however in some alternative embodiments, a vacuum may not be required.

After the glass bond 152 is formed, the remaining elements of the laser-CRT (such as described with reference to FIG. 1) are assembled to complete the laser-CRT.

The end result includes an epoxy-free laser-CRT with increased lifespan, less corrosion and safely sealed from voltage and other dangerous seepage. Additionally, the laser can be manufactured at low cost.

System

FIG. 16 is a schematic diagram of one example of a projection system 160 which illustrates how adjusting the e-beam current can be advantageous. FIG. 16 shows a plurality of laser-CRTs including a first laser-CRT 161, a second laser-CRT 162, and a third laser-CRT 163, each of which can be individually controlled by an e-beam current control system 165. The beams from the laser-CRTs are combined in a suitable beam combiner 164 such an x-prism and then projected by suitable projection optics 166 onto a screen 168. One example of such a real-world system is a projection system in which the three laser-CRTs provide a red image, a green image and a blue image that are combined and then projected onto a screen to provide a full-color image. In order to properly balance the color combination to provide a desired color balance, each of the laser-CRT's can be individually adjusted via the control system. This adjustment could be accomplished for example manually such as by a user who individually manipulates the controls for each laser-CRT, or automatically by using sensors as feedback into the current control system that then controls the individual CRTs to provide the desired color balance.

In one embodiment the projection system may be implemented using a spatial light modulator (SLM) situated in each beam path. Each SLM operates by individually modulating the pixels defined by the SLM. The SLM may be of any suitable type; for example it may be a transmissive SLM such as a liquid crystal panel, or it may be a reflective SLM such as a grating light valve (GLV) or a digital micro-mirror device (DMD). For purposes of illustration, FIG. 16 shows the transmissive type; it should be clear that the principle of SLM modulation applies to all types of SLMs.

In the embodiment shown in FIG. 16, a first SLM 171 is arranged in the beam path from the first laser-CRT 161, a second SLM 172 is arranged in the beam path from the second laser-CRT 162, and a third SLM 173 is arranged in the beam path from the third laser-CRT 163. A suitable SLM control circuit (not shown) is connected to each SLM. Each pixel of the SLM is individually modulated responsive to image data, and therefore the laser-CRTs are used primarily as an illumination source. Accordingly, the e-beam control system 165 in that embodiment would control the laser-CRTs to provide an apparently constant light source to each pixel. For this purpose, the laser-CRTs may illuminate the SLMs in synchronization with the modulation of each pixel.

In alternative embodiments the SLMs are eliminated and the modulation is performed by controlling each individual laser-CRT to produce the desired image. For example, in such embodiments the red laser-CRT is modulated with red image data, the green laser-CRT is modulated with green image data, and so forth in such a manner to create the desired image.

For at least these above stated reasons, a laser-CRT-based projection system described herein can become available to consumers, for example, for use in grating light valve projectors and other projection display devices. The laser-CRT may also be utilized for other application, such as optical switches, optical routers, and medical lasers.

It will be appreciated by those skilled in the art, in view of these teachings, that alternative embodiments may be implemented without deviating from the spirit or scope of the invention. This invention is to be limited only by the following claims, which include all such embodiments and modifications when viewed in conjunction with the above specification and accompanying drawings.

What is claimed is:

1. An epoxy-free faceplate for a laser-CRT comprising:
a laser structure including an active gain layer, and first and second mirrors on opposite sides of said active gain layer; and
a transparent substrate thermal expansion matched to said laser structure and bonded to said laser structure, such that a highly uniform interface is formed between said laser structure and said substrate.

2. The epoxy-free faceplate of claim 1, wherein said transparent substrate directly adjoins said laser structure.

3. The epoxy-free faceplate of claim 2, wherein said transparent substrate is diffusion bonded to said laser structure.

4. The epoxy-free faceplate of claim 1, wherein said uniform interface comprises a fastening layer formed by sol-gel bonding.

5. The epoxy-free faceplate of claim 4, wherein said fastening layer is uniformly spin-coated to form said highly uniform interface.

6. The epoxy-free faceplate of claim 4, wherein a coefficient of heat expansion of said fastening layer approximately matches a coefficient of heat expansion of said transparent structure and said laser structure.

7. The epoxy-free faceplate of claim 4, wherein an index of refraction of said fastening layer approximately matches an index of refraction of said transparent substrate.

8. The epoxy-free faceplate of claim 4, wherein a bonding temperature of said sol-gel bonding that forms said fastening layer is about 300° C. or less.

9. The epoxy-free faceplate of claim 1, wherein said transparent substrate comprises one of sapphire, YAG, and quartz glass.

10. The epoxy-free faceplate of claim 1, wherein said active gain layer comprises a single crystal wafer comprising a II-VI semiconductor compound.

11. The epoxy-free faceplate of claim 1, wherein said active gain layer comprises a single crystal layer including at least one of II-VI and III-V compounds grown on a sacrificial substrate.

12. The epoxy-free faceplate of claim 1, wherein said active gain layer comprises a plurality of quantum wells.

13. The epoxy-free faceplate of claim 1, wherein said first mirror comprises a total reflector formed on a first surface of said active gain layer.

14. The epoxy-free faceplate of claim 1, wherein said second mirror comprises a partially reflective layer formed on a second side of said active gain layer.

15. The epoxy-free faceplate of claim 14, wherein said partially reflective layer is bonded to said transparent substrate.

16. An epoxy-free faceplate for a laser-CRT comprising:
a laser structure including an active gain layer and first and second mirrors on opposite sides of said active gain layer; and
a transparent substrate diffusion bonded to said laser structure, thereby providing a uniform interface between the laser structure and the substrate.

17. The epoxy-free faceplate of claim 16, wherein said transparent substrate directly adjoins said laser structure.

18. The epoxy-free faceplate of claim 16, wherein said transparent substrate comprises one of sapphire, YAG, and quartz glass.

19. The epoxy-free faceplate of claim 16, wherein said active gain layer comprises a single crystal wafer comprising a II-VI semiconductor compound.

20. The epoxy-free faceplate of claim 16, wherein said active gain layer comprises a single crystal layer including at least one of II-VI and III-V compounds grown on a sacrificial substrate.

21. The epoxy-free faceplate of claim 16, wherein said active gain layer comprises a plurality of quantum wells.

22. An epoxy-free faceplate for a laser-CRT comprising:
a laser structure including an active gain layer and first and second mirrors on opposite sides of said active gain layer;
a transparent substrate; and
a highly uniform fastening layer that bonds said laser structure and said transparent substrate, said fastening layer formed by sol-gel bonding.

23. The epoxy-free faceplate of claim 22, wherein said transparent substrate comprises one of sapphire, YAG, and quartz glass.

24. The epoxy-free faceplate of claim 22, wherein said active gain layer comprises a single crystal wafer comprising a II-VI semiconductor compound.

25. The epoxy-free faceplate of claim 22, wherein said active gain layer comprises a single crystal layer including at least one of II-VI and III-V compounds grown on a sacrificial substrate.

26. The epoxy-free faceplate of claim 22, wherein said active gain layer comprises a plurality of quantum wells.

27. The epoxy-free faceplate of claim 22, wherein said fastening layer has a melting point greater than 500° C.

28. The epoxy-free faceplate of claim 27, wherein said fastening layer comprises a bonding temperature of about 300° C. or less.

29. The epoxy-free faceplate of claim 22, wherein said fastening layer comprises a coefficient of thermal expansion that matches a coefficient of thermal expansion of said transparent substrate and said laser structure.

30. A method of making an epoxy-free faceplate for a laser-CRT comprising:
providing a laser structure that includes an active gain layer that has first and second mirrors disposed on opposite sides thereof;
providing a transparent substrate that is thermal expansion matched to said laser structure; and
bonding said laser structure to said transparent substrate by a bonding process at about 300° C. or less.

31. The method of making an epoxy-free faceplate of claim 30, wherein the bonding step comprises connecting said laser structure to said transparent substrate such that they are directly adjoined.

32. The method of making an epoxy-free faceplate of claim 31, wherein the bonding step comprises diffusion bonding.

33. The method of making an epoxy-free faceplate of claim 30, wherein the bonding step comprises spin-coating a layer of bonding material onto at least one of said laser structure and said transparent substrate.

34. The method of making an epoxy-free faceplate of claim 30, wherein the bonding step comprises sol-gel bonding.

35. A method of making an epoxy-free faceplate for a laser-CRT:
providing a laser structure that includes an active gain layer that has first and second mirrors formed on opposite sides thereof;
providing a transparent substrate; and
diffusion bonding said laser structure and said transparent substrate.

36. The method of claim 35, wherein said transparent substrate is one of sapphire, YAG, and quartz glass.

37. The epoxy-free faceplate of claim 35, wherein said active gain layer comprises a single crystal wafer comprising a II-VI semiconductor compound.

38. The epoxy-free faceplate of claim 35, wherein said active gain layer comprises a single crystal layer including at least one of II-VI and III-V compounds grown on a sacrificial substrate.

39. The epoxy-free faceplate of claim 35, wherein said active gain layer comprises a plurality of quantum wells.

40. The method of claim 35, further comprising polishing at least one of said active gain layer and said transparent substrate.

41. The method of claim 40, wherein the step of polishing comprises magnetorheological polishing.

42. A method of making an epoxy-free faceplate for a laser-CRT comprising:
providing a laser structure that includes an active gain layer that has first and second mirrors formed on opposite sides thereof; and
providing a transparent substrate; and
bonding said laser structure and said transparent substrate using a sol-gel bonding process.

43. The method of claim 42, wherein said sol-gel bonding process comprises spin-coating sol-gel material on at least one of said laser structure and said transparent substrate.

44. The method of claim 43, wherein the step of spin-coating sol-gel material comprises spin-coating a sol-gel solution that has SiO₂ therein.
